(19) United States
(12) Patent Application Publication
(10) Pub. No.: US 2006/0168323 A1
(43) Pub. Date: Jul. 27, 2006

(54) Transcoding apparatus and method for distributed multimedia transmission network provided with transcoder

(75) Inventors: Chan-Yul Kim, Bucheon-si (KR); Sung-Jin Park, Suwon-si (KR); Chang-Sup Shim, Seoul (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/179,855

(22) Filed: Jul. 12, 2005

(30) Foreign Application Priority Data
Nov. 18, 2004 (KR) 2004-94647

(51) Int. Cl. G06F 15/173

(52) U.S. Cl. 709/238

(57) ABSTRACT

Disclosed is a transcoding method and apparatus for a mobile communication system provided with a transcoder. The transcoding method includes receiving a request for media content and codec information required for the requested media content, receiving the requested media content from a media content server and determining whether the received codec information exists, transformatting a format of the received media content by a codec of the codec information if the received codec information exists, searching the codec list and installing the codec information and transformatting the format of the received media content using the installed codec, determining whether a transmission bandwidth through which the transformatted media content are transmitted is smaller than a bandwidth of the transformatting codec, transrating the format of the media content by a codec suitable for the transmission bandwidth if the transmission bandwidth is smaller than the bandwidth of the transformatting codec, and transmitting the transrated media content.

### CLAIM OF PRIORITY

This application claims priority to an application entitled “Transcoding Apparatus and Method for Distributed Multimedia Transmission Network Provided with Transcoder,” filed in the Korean Intellectual Property Office on Nov. 18, 2004 and assigned Serial No. 2004-94647, the contents of which are hereby incorporated by reference.

### BACKGROUND OF THE INVENTION

1. Field of the Invention

The present invention relates generally to the transcoding of a mobile communication system, and more particularly to a transcoding method and apparatus for a mobile communication system provided with a transcoder.

2. Description of the Related Art

With rapid technical developments in modern society, users of mobile phones or computers increasingly demand high-speed delivery of media content. As used herein, media content means information that includes audio, video, data, photograph, image, text and other content.

At present, computer and networking technology have been combined. For example, digitalized media content is transferred through a final user computer, and the final user plays the media content by executing a media player.

There are diverse types of digital expression that can be used for the media content. Generally, these types are defined according to management information related to a file format, bit rate, communication protocol, physical medium, compression algorithm and media contents. These types digitalized media content depends on many factors such as the executing computing and networking techniques, characteristics of the contents themselves, etc.

For example, many types of digitalized media content are defined according to their file formats. Typical file formats are QUICK TIME, MPEG, AVI, MP3, REAL, WINDOW MEDIA, H.264 VIDEO CODING AND PALM-COMPATIBLE FORMAT. The format can be defined as a media content file or data stream.

The types of digitalized media content may also be classified according to the type of encoding or compression techniques used (to reduce the physical size of the media content) and the type of physical media (that support the storage of the media content). Additionally, the types of digitalized media content may be classified according to communication protocols (used to transmit the media content) or the types of the protocols.

As the number of media players rapidly increases, there is a great difference between the various types of media content and diverse functions of the client device that processes the content. As a result, the technique selection process for the final user becomes greatly complicated. For example, the user may not have confidence that a given media player can reproduce the media content of the type in which the user takes an interest in some cases.

In a conventional network, a transcoder for the multimedia transmission is not provided and a specified bandwidth is assigned in advance to the multimedia path. Thus, the priority of multimedia transmission between network nodes is determined by the service provider's transmission of the multimedia through a predefined bandwidth.

Accordingly, if the transmission/reception environments between the multimedia content server and the client terminal are limited, the transcoding of the transmission bitstream is required. The transmission/reception environments include the data transmission rate of the terminal, size of a memory, size of an LCD panel, etc., even a communication network where the media content of the same type are applied.

A transcoder performs transcoding for converting the format of a source multimedia into the format of a destination multimedia, where the communication links of the different types of media content are intended to communicate with each other. For example, a transcoder can convert the MPEG-2 multimedia into multimedia having the format of H.264.

A conventional multiple type transcoding service is provided offline by content providers before the corresponding media content is open to the public. However, this causes an unavoidable delay in transcoding. Although devices for realtime transcoding of multimedia content are well known in the art, these devices can transcode the media content only to one destination format. Thus, they cannot transfer the media content with multiple destination formats. Since the offline multiple format transcoding service is expensive, the content provider has no choice but to transcode the media content to the limited number of destination types. Accordingly, a user having a media player that cannot cope with the transcoded files of the destination type cannot access the content at all. In response, a user is required to frequently download the media player that provides the corresponding content.

Moreover, since the users use various kinds of client media players, content providers are required to provide the original media content with a plurality of source types. Otherwise, a content provider cannot transfer its content to the greatest number of users.

### SUMMARY OF THE INVENTION

Accordingly, the present invention has been designed to reduce or overcome the above limitations, as well as other problems occurring in the prior art. In accordance with the principles of the present invention an apparatus is provided that maintains the original picture quality at maximum by converting multimedia data to be transmitted using a codec having a better compression rate if the bandwidth of a network that is provided with a transcoder is reduced when the multimedia data is transmitted to a neighboring node.

According to the present invention, a network node that neighbors on a subscriber terminal preferentially transmits the multimedia data in a format required by the subscriber terminal, and if there is no codec required by the subscriber terminal, it provides the multimedia data in a requested format by downloading required codec information of an upper node.

One aspect of the present invention, a transcoding apparatus for use with a distributed multimedia transmission network is provided. The transcoding apparatus includes a transcoder connected to a media content server, which includes a codec router provided with a list of codecs that are supportable in the network, the transcoder receives media content requested by subscriber terminals of the media content server and codec information required for the media content, and performs a transcoding according to the codec information.

In another aspect of the present invention, there is provided a transcoding method for a distributed multimedia transmission network provided with a media content server, a codec router connected to the media content server having a list of codecs that are supportable in the network and a transcoder connected to the codec router. The method including the steps of receiving a request for media content and codec information required for the requested media content, receiving the requested media content from the media content server and determining whether the received codec information exists, transformatting a format of the received media content by a codec of the codec information if the received codec information exists, searching the codec list and installing the codec information and transformatting the format of the received media content using the installed codec, determining whether a transmission bandwidth through which the transformatted media content are transmitted is smaller than a bandwidth of the transformatting codec, transrating the format of the media content by a codec suitable for the transmission bandwidth if the transmission bandwidth is smaller than the bandwidth of the transformatting codec, and transmitting the transrated media content.

In still another aspect of the present invention, there is provided a transcoding method for a distributed multimedia transmission network provided with a media content server, a codec router connected to the media content server and having a list of codecs that are supportable in the network and a transcoder connected to the codec router. The method including the steps of receiving a request for media content and codec information required for the requested media content, receiving the requested media content from the media content server and determining whether the received codec information exists, transformatting a format of the received media content using a codec of the codec information if the received codec information exists, searching a database of the codec and installing the searched codec information and transformatting the format of the received media content using the installed codec if the received codec information does not exist, and transmitting the transformatted media content to a subscriber terminal that has requested the media content.

### BRIEF DESCRIPTION OF THE DRAWINGS

The present invention will be more apparent from the following detailed description taken in conjunction with the accompanying drawings, in which:

FIG. 1 is a view illustrating a network construction according to an embodiment of the present invention;

FIG. 2 is a flowchart illustrating transformatting and transrating processes performed between networks according to an embodiment of the present invention; and

FIG. 3 is a flowchart illustrating the operation of a network according to an embodiment of the present invention.

### DETAILED DESCRIPTION

Embodiments of the present invention will be described in detail hereinafter with reference to the accompanying drawings. For the purposes of clarity and simplicity, a detailed description of known functions and configurations incorporated herein will be omitted as it may obscure the subject matter of the present invention. The terms are defined in consideration of their functions in the present invention and may differ in accordance with the intention of a user/operator or custom. Accordingly, they are defined based on the contents of the entire description of the present invention.

According to the present invention, a network is provided with a plurality of codec DBs that are supportable in an upper node. The network performs a transformatting that provides multimedia in a format requested by a user. The network is also provided with a transcoder that changes the format of the multimedia to a format that provides the best picture quality according to the change of the bandwidth.

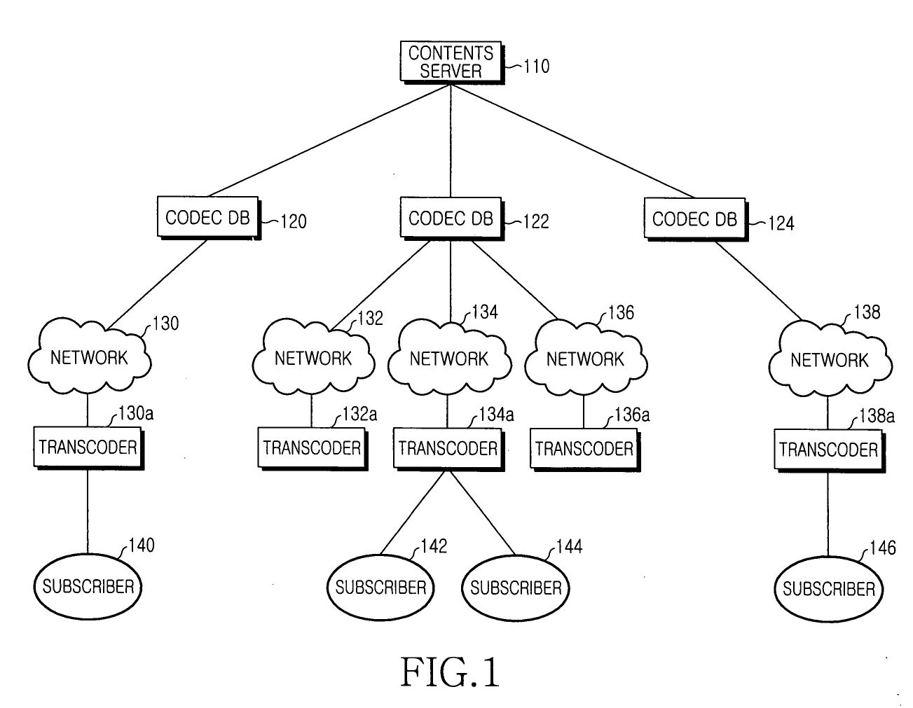

FIG. 1 is a view illustrating a network construction according to the embodiment of the present invention.

Referring to FIG. 1, the network includes subscriber terminals 140 to 146, network nodes 130 to 138 provided with transcoders 130a to 138a, respectively, codec DB routers (i.e., DBs) 120 to 124 and a content server 110 for providing media content.

The subscriber terminals 140 to 146 may be a PC, a mobile terminal, a PDA (Personal Digital Assistant), etc. The subscriber terminals 140 to 146 request digitalized media content from the content server 110 and receive and execute the requested media content.

The network nodes 130 to 138 are provided with limited codecs that support the media content. The network nodes 130 to 138 receive the media content requested by the subscriber terminals 140 to 146 and codec information. If a codec of the received codec information exists, the network nodes convert the format of the media contents to the corresponding format, and provide the converted media content to the corresponding subscriber terminals 140 to 146. However, if the codec of the received codec information does not exist, the network nodes search for the codec DB of the closest upper node among the codec DB routers 120 to 124. Then the network nodes download the codec that supports the received media content and provides the media content to the corresponding subscriber terminal.

The network nodes 130 to 138 are provided with transcoders 130a to 138a that perform the transcoding among communication nodes, respectively. The transcoders 130a to 138a perform the transrating for converting the format of the requested media content into a format that supports the best picture quality according to the bandwidth conditions among the communication nodes.

The codec DB routers 120 to 124 are provided with a codec list that support all of the media content provided by the content server 110. The codec DB routers 120 to 124 make the codecs requested by the subscriber terminals 140 to 146 available to the networks connected to the corresponding subscriber terminals.

The content server 110 has a plurality of subscribers 140 to 146 as members thereof, and supports diverse multicasting/multimedia data, i.e., media content, requested by the subscribers 140 to 146.

Explained first is the transformatting aspect of the network if the service subscriber 140 requests the media content to the corresponding content server 110 according to the preferred embodiment of the present invention.

The service subscriber terminal 140 transmits a request for media content reception and codec information required by the subscriber terminal 140 to the first network 130. In this case, it is assumed that the codec information requested by the subscriber terminal 140 corresponds to H.264 AVC and AAC+ Audio.

If the first network node 130 is provided with a codec that coincides with the codec information, it receives the media content requested by the user from the contents server 110. Then it transcodes the received media content to the corresponding format, and transmits the transcoded media content to the subscriber terminal 140.

Meanwhile, if the first network node 130 is not provided with the codec that coincides with the codec information, it transmits the codec information to the second network 132. The second network 1132 that has received the codec information searches the codec list of the adjacent codec DB router 122, downloads the corresponding codec, and transmits the downloaded codec to the first network node 130. The first network node 130 installs the downloaded codec, transcodes the requested media contents to the requested format, and transmits the transcoded media content to the subscriber terminal.

Explained next is the transrating aspect of the network if the service subscriber 140 requests the media content to the corresponding contents server 110 according to the preferred embodiment of the present invention.

If traffic between the first network node 130 and the second network node 132 increases and the transmission bandwidth is reduced, errors may increase between the first network node 130 and the second network node 132. Consequently resolution of the media contents being provided to the codec of the present state may be damaged due to a high compression rate. Accordingly, the transcoder 130a of the first network node 130 transrates the media content to a format whereby the media contents can be transmitted without being damaged through the transmission bandwidth. Then, the first network node 130 transmits the media content to the subscriber terminal 140 in the transrated format.

Thereafter, the subscriber terminal 140 can reproduce the transmitted media content with the best resolution.

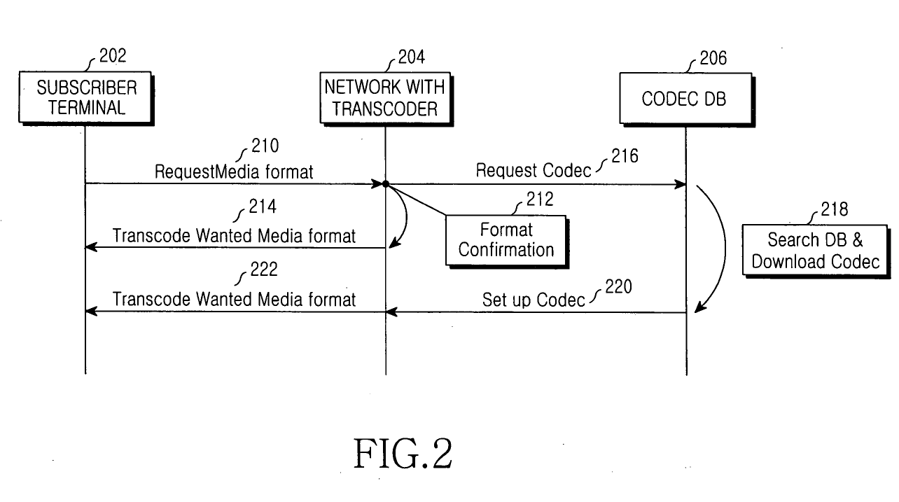

FIG. 2 is a flowchart illustrating the transformatting and transrating processes performed between networks according to the preferred embodiment of the present invention.

Referring to FIG. 2, the network includes a subscriber terminal 202 that belongs to a specified media content server, a network 204, provided with a transcoder, for connecting the subscriber terminal 202 to the media content server, and a codec DB router 206 provided with a plurality of codecs that support the media content provided by the content server.

At step 210, the subscriber terminal 202 transmits a request for the media content and required codec information to the network provided with the transcoder.

At step 212, the network 204 provided with the transcoder determines if it has a codec of the codec information. If it has the codec of the received codec information, it proceeds to step 214, transformats the media content to the format corresponding to the codec information, and then transmits the transformatted media content to the subscriber terminal 202.

If the network 204 does not have the codec of the codec information, the network provided with the transcoder transmits the received codec information to the codec DB router 206. The codec DB router 205 that has received the codec information searches its own list and downloads the codec of the searched codec information at step 218. If the codec DB router 206 transmits the downloaded codec information to the network 204 provided with the transcoder at step 220, the network 204 installs the codec of the downloaded codec information. At step 222, the network 204 provided with the transcoder transformats the format of the media content through the installed codec, and transmits the transformatted media content to the subscriber terminal 202.

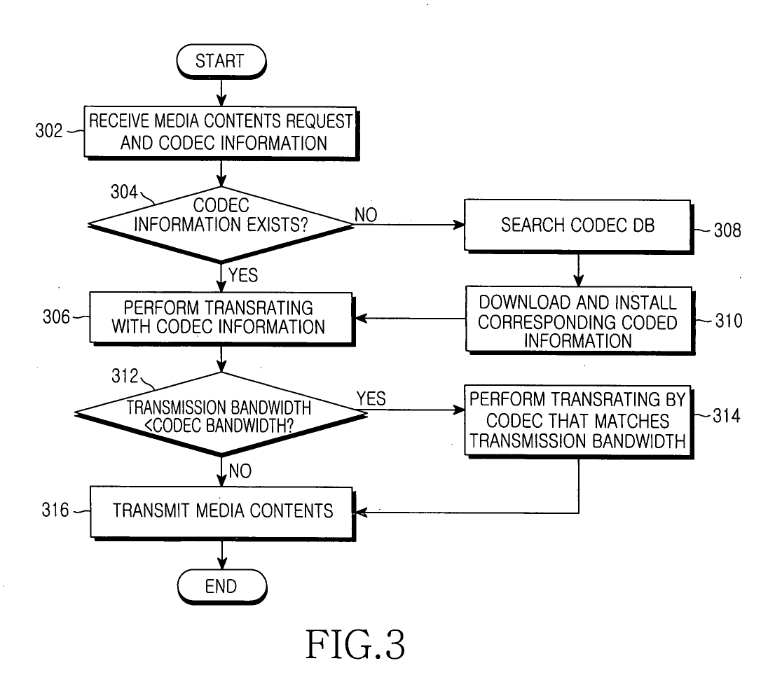

FIG. 3 is a flowchart illustrating the operation of the network according to the preferred embodiment of the present invention.

Here, the network is provided with a transcoder that performs the transformatting and the transrating.

Referring to FIG. 3, the network receives the media content request and the codec information required for the requested media content at step 302.

At step 304, the network determines whether the received codec information exists. If the received codec information exists, the network transformats the format of the media content using the corresponding codec at step 306, and then proceeds to step 312.

If the received codec information does not exists, the network searches the codec DB at step 308, downloads and installs the codec information at step 310, and then proceeds to step 306. At step 306, the network transformats the format of the media content by the installed codec at step 306.

At step 312, the network confirms whether the transmission bandwidth through which the media content are transmitted is smaller than the bandwidth of the transformatted format. If the transmission bandwidth is smaller than the bandwidth of the transformatted format, the network transrates the media content to a format suitable for the transmission bandwidth at step 314, and transmits the transrated media content at step 316. For example, a format suitable for the transmission bandwidth is one in which a predetermined error threshold is not realized.

If the transmission bandwidth is not smaller than the bandwidth of the transformatted format, the network transmits the transformatted media content at step 316.

As described above, according to the present invention, since the network supports the transcoding, it is not required to directly download a new codec required for the media content requested by the subscriber if the new codec appears. Thus the subscriber can use the media content irrespective of the kind of the codec at the subscriber terminal. Additionally, even if the transmission bandwidth is changed due to the traffic between the communication nodes, the subscriber can use the media content having an optimum picture quality through the transrating of the media content by a proper codec.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A transcoding apparatus for use with a distributed multimedia transmission network provided with a transcoder connected to a media content server, the transcoding apparatus comprising:
a codec router provided with a list of codecs that are supportable in the network; and
the transcoder for receiving media content requested by subscriber terminals of the media content server and codec information required for the media content, and performing a transcoding according to the codec information.

2. The transcoding apparatus as claimed in claim 1, wherein the transcoding is further performed according to a transmission bandwidth.

3. The transcoding apparatus as claimed in claim 1, wherein the transcoder performs the transcoding by determining whether a codec of the received codec information exists, and if the codec of the received codec information does not exist, downloading and installing the codec from the list of the codec router.

4. The transcoding apparatus as claimed in claim 3, further including the transcoding apparatus receiving the requested media content from the content server, and transformatting a format of the media content by the installed codec.

5. The transcoding apparatus as claimed in claim 3, wherein the transcoder receives the requested media content from the content server and transformatting the format of the media content by the codec if the codec of the received codec information exists.

6. The transcoding apparatus as claimed in claim 5, wherein the transcoder determines whether a transmission bandwidth through which the media content are transmitted is not larger than a bandwidth of the transcoded format; and
if the transmission bandwidth is not larger than the bandwidth of the transcoded format, transrating the format of the content by the codec that satisfies the transmission bandwidth.

7. A transcoding method for a distributed multimedia transmission network provided with a media content server, a codec router connected to the media content server having a list of codecs that are supportable in the network and a transcoder connected to the codec router, the transcoding method comprising the steps of:
receiving a request for media content and codec information required for the requested media content;
receiving the requested media content from the media content server;
determining whether the received codec information exists;
transformatting a format of the received media content by a codec of the codec information if the received codec information exists;
searching a database of the codec;
installing the searched codec information; and
transformatting the format of the received media content by the installed codec if the received codec information does not exist.

8. The transcoding method as claimed in claim 7, further including the step of transmitting the transformatted media content to a subscriber terminal that has requested the media content.

9. The transcoding method as claimed in claim 8, wherein the transmitting step comprises the substeps of:
determining whether a transmission bandwidth of the media content is smaller than a bandwidth of the transformatted format;
transrating the format of the media content by a codec suitable for the transmission bandwidth if the transmission bandwidth is smaller than the bandwidth of the transformatted format; and
transmitting the media content with the transrated format.

10. A transcoding method for a distributed multimedia transmission network provided with a media content server, a codec router connected to the media content server having a list of codecs that are supportable in the network and a transcoder connected to the codec router, the transcoding method comprising the steps of:
receiving a request for media content and codec information required for the requested media content;
receiving the requested media content from the media content server;
determining whether the received codec information exists;
transformatting a format of the received media content by a codec of the codec information if the received codec information exists;
searching the codec list;
installing the codec information;
transformatting the format of the received media content using the installed codec;
determining whether a transmission bandwidth through which the transformatted media content are transmitted is smaller than a bandwidth of the transformatting codec;
transrating the format of the media content by a codec suitable for the transmission bandwidth if the transmission bandwidth is smaller than the bandwidth of the transformatting codec; and
transmitting the transrated media content.

11. The transcoding method as claimed in claim 10, further comprising the step of transmitting the transformatted media content if the transmission bandwidth is not smaller than the bandwidth of the transformatting codec.
